(19) United States
(12) Patent Application Publication
(10) Pub. No.: US 2015/0258899 A1
(43) Pub. Date: Sep. 17, 2015

(54) Driveshaft Electric Generator/Braking System

(71) Applicant: Sam Anvari, Denton, TX (US)

(72) Inventor: Sam Anvari, Denton, TX (US)

(21) Appl. No.: 14/204,450

(22) Filed: Mar. 11, 2014

(51) Int. Cl. B60L 11/12; B60L 7/12

(52) U.S. Cl. CPC B60L 11/12; B60L 7/12

(57) ABSTRACT

A vehicle such as a large truck may generate electricity for operating a hybrid engine or recharging batteries by use of an electricity generating driveshaft. The electricity generating driveshaft is comprised of a magnetized driveshaft which acts as a rotor, and a series of copper wire coils surrounding the magnetized driveshaft which acts as a stator in an electrical generator. As the magnetized driveshaft spins as a result of power from the hybrid engine, an electrical field is created which is captured by the copper wire coils and used to power the hybrid engine or recharge a supercapacitor. A truck may also be slowed by selectively activating magnets surrounding the driveshaft which slows the driveshaft rotation and thereby slows the speed of the truck to bring the truck to a stop while the driveshaft continues to generate electricity.

### CROSS-REFERENCE TO RELATED APPLICATIONS

None.

### STATEMENT REGARDING FEDERALLY SPONSORED RESEARCH OR DEVELOPMENT

No part of the invention disclosed herein was the subject of federally sponsored research or development.

### THE NAMES OF THE PARTIES TO A JOINT RESEARCH AGREEMENT

None.

### REFERENCE TO A SEQUENCE LISTING

Not applicable.

### BACKGROUND OF THE INVENTION

1. Field

The field of the invention disclosed herein is an article of manufacture and method for generating electricity from the rotating driveshaft of a motor vehicle and using the driveshaft to slow the vehicle to a stop.

2. Description of the Related Art

Vehicles have been powered by a variety of sources over the years. Before the invention of the internal combustion engine, vehicles were powered by animals, wind, and manpower. Since the abuse of the internal combustion engine, vehicles have been fueled by gasoline, diesel oil, natural gas, ethanol and combinations of ethanol and gasoline. These fuels are expensive to use, difficult to obtain and transport and are becoming increasingly scarce. In response to these problems with the so called “fossil fuels”, vehicles are being powered by all electric motors or hybrid combinations of electric/gasoline or electric/diesel fuel engines. The use of electric motors or electric/fossil fuel hybrid engines is hindered by the difficulty of providing electricity to power the electric motor or the electric portion of the hybrid engine. Electric engines receive energy from batteries. However, the batteries are heavy decreasing the efficiency of the electric motor. The batteries also have limited storage capacity thereby decreasing the range of the vehicle driven by an electric motor. Moreover, stations to recharge the batteries are few limiting the usefulness of electric vehicles.

Electrical generators have been in use for many years in different applications. The general definition of a generator is a device that converts mechanical energy into electrical energy. This is possible due to the principle of electromagnetism. As this electrical energy is produced, the generator will cause electric current to flow through an external circuit. Typically, generators are made up of an arrangement of magnets, copper winding and a rotor, which ultimately produce electricity from mechanical power. In a generator powered by a diesel engine, the mechanical energy is provided from the chemical energy that stems from the combustion of diesel fuel by the engine This mechanical energy provided to the generator is eventually converted into electrical power based on the principle of electromagnetic induction. As the magnetic field is changed, a current is produced through the conductor within the generator.

The electric generator consists of two main components, a rotor and a stator. Typically, a stator is composed of one or more magnets and copper winding, and the rotor is a metal loop or shaft that rotates within the stator. When the rotor revolves within the stator, an electric current is generated because the magnetic field in relation to the electrons changes. With every complete turn of the rotor within the stator, the magnetic field is changed, creating electricity which travels to an external electrical circuit through a coil or the copper winding. This concept of electromagnetism can be applied to vehicles, or virtually anything that utilizes a drive axle or drive shaft.

Truck braking systems may be of the disc type wherein a disc constructed from heat resistant material such as asbestos presses against a rotor attached to the axle which slows the truck by friction. Another type of braking system is the drum system in which arced brake pads line the inside well of the tire and slow the brake by friction when pushed against the tire well. Both the disc type and drum type brakes are applied hydraulically or by compressed air. Both types of braking systems use friction to slow the vehicle and thus, develop large amounts of heat in the process. The heat developed by braking can be harmful to the mechanical components of the braking system and may cause the tire to burst into flame. Further, these brake pads, either disc or drum, must be replace periodically in order to function properly. Those brake pads which are constructed from asbestos, shed asbestos fibers into the local environment which may be detrimental to persons and animals in the vicinity.

### BRIEF SUMMARY OF THE INVENTION

The invention disclosed herein is a modification of the driveshaft of a vehicle to convert the drive shaft into an electrical generator which will produce electricity to charge a supercapacitor which can power an electric motor or hybrid engine. Specifically, the driveshaft is constructed so as to use the driveshaft as a rotor and surround the driveshaft rotor with a stator. As the driveshaft rotates from the power of the engine, a magnetic field is created the electricity generated is transferred to the batteries or to a storage cell.

The driveshaft invention may also be used to slow the vehicle. The driveshaft may be selectively magnetized on direction of the driver. The interaction between the magnetized driveshaft and the rotor will slow the rotation of the driveshaft which in turn will slow the speed at which the truck is moving and bring the truck to a stop without the application of traditional braking systems.

### BRIEF DESCRIPTION OF THE SEVERAL VIEWS OF THE DRAWINGS

A better understanding of the invention disclosed herein may be had by review of the following drawings/figures:

FIG. 1 is a view of the driveshaft of a truck extending from the transmission to the differential.

FIG. 2 is a cross section of the driveshaft showing the rotor/stator configuration.

FIG. 3 is a view of the connection of the driveshaft of a truck to the brake pedal.

FIG. 4 is a view of the connection of a sensor to the brake pedal.

### DETAILED DESCRIPTION OF THE INVENTION

Electrical generators have been in use for many years in different applications. The general definition of a generator is a device that converts mechanical energy into electrical energy. This is possible due to the principle of electromagnetism. As this electrical energy is produced, the generator will cause electric current to flow through an external circuit. Typically, generators are made up of an arrangement of magnets, copper winding and a rotor, which ultimately produce electricity from mechanical power. In a generator powered by a diesel engine, the mechanical energy is provided from the chemical energy that stems from the combustion of diesel fuel by the engine This mechanical energy provided to the generator is eventually converted into electrical power based on the principle of electromagnetic induction. As the magnetic field is changed, a current is produced through the conductor within the generator.

The electric generator consists of two main components, a rotor and a stator. Typically, a stator is composed of one or more magnets and copper winding, and the rotor is a metal loop or shaft that rotates within the stator. When the rotor revolves within the stator, an electric current is generated because the magnetic field in relation to the electrons changes. With every complete turn of the rotor within the stator, the magnetic field is changed, creating electricity which travels to an external electrical circuit through a coil or the copper winding. This concept of electromagnetism can be applied to vehicles, or virtually anything that utilizes a drive axle or drive shaft.

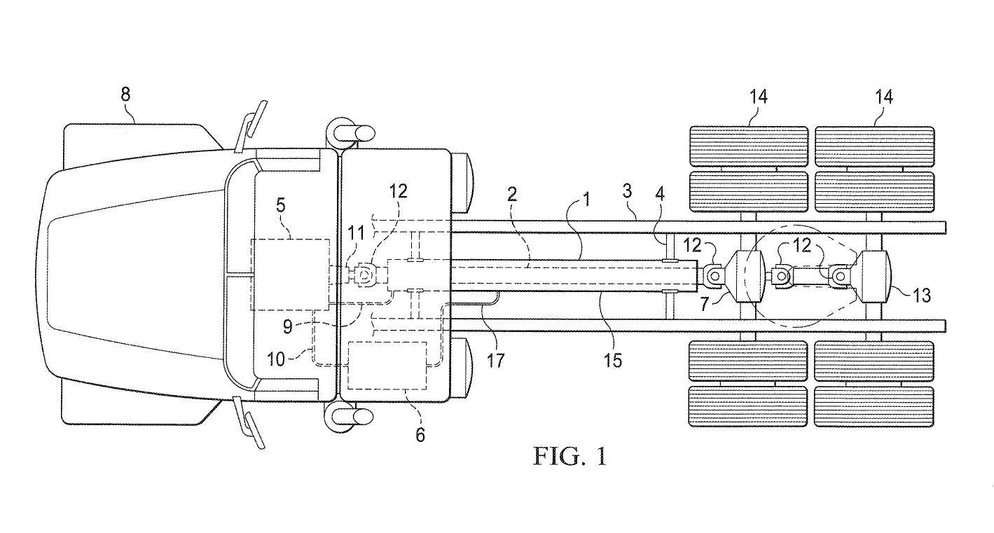

A motor vehicle is powered by an engine which may be connected to a transmission. As shown in FIG. 1, a truck 8 may be powered by a hybrid engine 5. Power from the hybrid engine 5 is transferred to the magnetized drive shaft 2 in the electricity generating driveshaft housing 1 by the transmission 11 which is connected to a magnetized driveshaft 2 by a universal joint 12. The electricity generating driveshaft housing 1 is attached to the frame 3 of the truck 8 by a plurality of brackets 4. The end of the magnetized driveshaft 2 distal from the transmission 11 is connected to the differential 7 by another universal joint 12 which may in turn be connected to a second differential 13 by another universal joint 12. The magnetized driveshaft 2 and the differential 12 spins in relationship to the engine power as governed by the transmission 11. The magnetized driveshaft 2 interacts with the differential 7 which causes the rear wheels 14 to turn, moving the truck 8 forward (or backward). The truck 8 may be equipped with a second differential 13 connected by universal joints 12 to the first differential 7 to drive another set of tires 14. The driveshaft 2 of the vehicle is magnetized and used as a rotor of an electrical generator. The magnetized driveshaft 2 is designed and constructed so as to be surrounded by surrounded by coils of copper wiring which acts as a stator 15 of an electricity generator. As the magnetized driveshaft 2 spins and interacts with the stator 15, an electric current is generated which may be used to recharge a supercapacitor or power an electric motor. The electricity generated by the magnetized drive shaft 2 in the electricity generating driveshaft housing 1 is transferred by electrical circuit 9 to power the hybrid engine 5. As the hybrid engine 5 operates, electricity is transferred by electrical circuit 10 to a supercapacitor or storage cell 6 for later use.

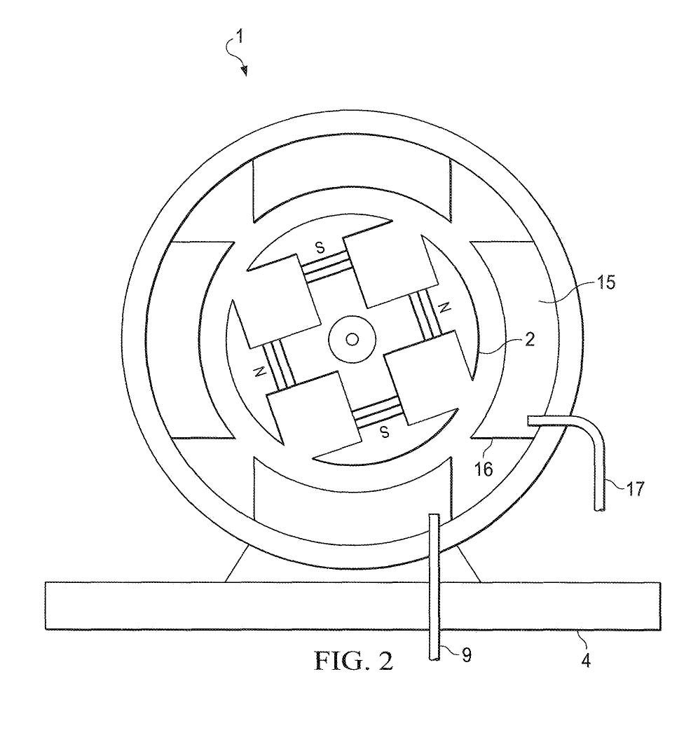

As shown in FIG. 2, the electricity generating driveshaft housing 1 is connected to the truck frame by a plurality of brackets 4 and consists of a magnetized driveshaft 2 surrounded by a stator 15 which is part of the electricity generating driveshaft housing 1 and which surrounds the magnetized driveshaft 2 with coils of copper wire 16. As the magnetized driveshaft 2 rotates by the power of the engine, electricity is generated and captured by the copper wire coils 16 and transferred to the electric circuits by copper wire conduits 17 and 9 to a supercapacitor and hybrid engine, respectively.

As an example of the application of the utility of the invention disclosed herein, it is known that after a Class 8 truck reaches cruising speed, approximately 160 Kw of electrical power is required to maintain a speed of 60-65 miles per hour powered only by an electric motor with little or no assistance from the diesel motor. This amount of electrical power is equivalent to 217.6 horsepower based on a conversion factor of 1 diesel horsepower equal to 0.746 Kw. Currently, there is nothing on the commercial market sustainable or sufficiently compact to provide this amount of electrical power, continuously, to a truck of any size. In other embodiments the amount of electricity generated may be varied depending on the length and girth of the driveshaft.

The engine and drive train on a Class 8 truck are robust. These engines, predominately diesel, produce a torque of over 1,000 lb./ft., and horsepower with a range of approximately 350 to 600 horse power. As diesel combustion occurs within the engine, chemical energy is converted into mechanical energy. This mechanical power gets transferred from the engine to the driveshaft, via the transmission. As a result the driveshaft rotates at approximately 1500 revolutions/minute at cruising speed of 60-65 miles per hour. The driveshaft is also connected at the end distal from the transmission connection to the differential, which transfers this mechanical power to the wheels, causing the vehicle to move.

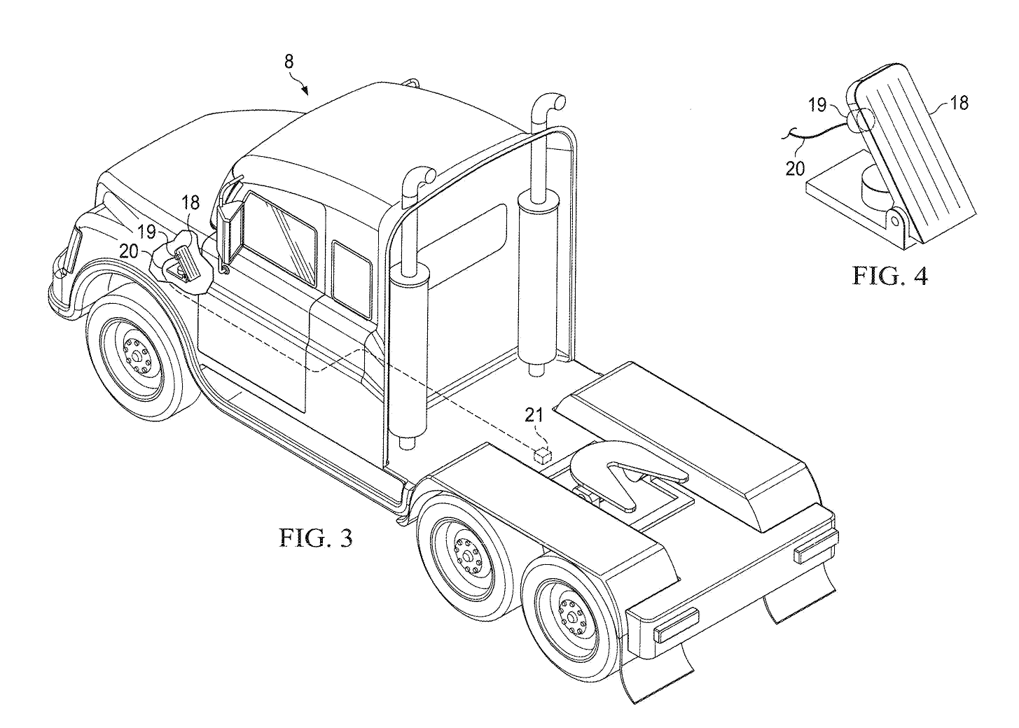

A typical class-8 truck with a fully loaded 53 foot long trailer usually weighs around 80,000 pounds. The braking power required to stop a vehicle of this weight is enormous. The current method for stopping these vehicles is with standard brakes, which are usually drum or disc brakes. In another embodiment of the invention disclosed herein, the driveshaft electrical generator may be used to help bring the vehicle to a stop while simultaneously generating electricity. The driveshaft of a typical class-8 truck is about 12-ft in length, and approximately 16-inches in diameter. When the driveshaft of a moving vehicle used to generate electricity from the existing mechanical power, net losses of energy will occur slowing the vehicle. Additionally, the driveshaft 2 may be selectively magnetized by the operator. As shown in FIGS. 3 and 4 the braking system of a truck 8 may be connected to the driveshaft 2 to permit periodic magnetization of the driveshaft 2 to slow the vehicle 8. An actuator 19 is attached to the brake pedal 18 of the truck 8. The actuator 19 is connected by electrical cable 20 to a connector box 21 to which the power cable 9 from the driveshaft 2 is connected. The actuator 19 will magnetize the driveshaft 2 upon depression of the brake pedal 18 by the operator when the operator wishes to slow or bring the truck 8 to a stop. The interaction of the selectively magnetized driveshaft 2 and surrounding stator 15 slows the rotation of the driveshaft 2 without the application of friction and concomitant development of heat. As a result several beneficial events have been accomplished. The vehicle has been slowed without using the traditional braking system, and mechanical energy has been converted into electrical energy, which can now be stored in a super capacitor and/or utilized by the electric motor on the truck either alone or in conjunction with the diesel motor to propel the vehicle. Further, the braking system which selectively magnetizes the driveshaft is much less prone to mechanical failure giving this system a longer life and toxic materials such as asbestos are not shed into the environment. In other embodiments different lengths and girths of driveshaft will produce different amounts of braking power derived from the driveshaft.

In yet another embodiment of the invention disclosed herein, the drive train may be used to generate electricity from mechanical energy while the vehicle is not moving. Even though the vehicle is not moving, the engine is still running, and converting chemical energy into mechanical energy, that does not get used by the vehicle. By installing a coupling/de-coupling mechanism at the end of the driveshaft, where it connects to the rear-differential, the driveshaft can be disconnected from the rear axle. As the truck is in idle, either at a red light, or in traffic, the driveshaft may be disconnected from the rear-axle, allowing the driveshaft to rotate freely. As the truck remains in gear spinning the driveshaft at a high speed allows the rotor/stator mechanism to convert the mechanical energy into electrical power. Once the truck is instructed to move forward, the driveshaft will couple to the rear differential, the electromagnetic generator will shut off, and the truck can move again.

The processes disclosed in this specification have tremendous potential to convert unused potential chemical/mechanical energy into electrical power to be used by the vehicle. This has several advantages. First, when demand for power and torque is low, the electrical motor can draw power from the super capacitor/storage cell to propel the truck. An electric motor used to power the truck and charged by the driveshaft electrical generator can also work in synchronization with the gasoline or diesel engine, to propel the vehicle allowing the engine to operate at a lower power. This synchronization reduces fuel consumption. By utilizing the driveshaft to help slow the vehicle less pressure is placed on the braking system making the braking system more efficient requiring less maintenance and repairs.

The invention disclosed herein may be applied to most any vehicle which utilizes a driveshaft to connect the transmission to the differential.

I claim:

1. An electricity generating driveshaft for a truck comprising:
a magnetized driveshaft;
a series of copper coils surrounding said magnetized driveshaft;
whereby, when said magnetized driveshaft spins as a result of power from an engine, electricity is generated which is captured by said copper coils for use to power a hybrid engine or recharging a supercapacitor.

2. A truck braking system comprising:
a driveshaft which is selectively magnetized;
an actuator attached to said truck braking system which selectively magnetizes said driveshaft;
a series of copper coils surrounding said magnetized driveshaft;
whereby the selective magnetization of said driveshaft interacts with said series of copper coils slowing the rotation of said driveshaft resulting in a decrease in the speed of the truck.
